(19) United States
(12) Patent Application Publication
(10) Pub. No.: US 2011/0267944 A1
(43) Pub. Date: Nov. 3, 2011

(54) Admission Control Systems and Methods

(76) Inventors: Paul Stjernholm, Lidingo (SE); Magnus Hurd, Stockholm (SE); Fredrik Persson, Marsta (SE); Lotta Boigt, Bromma (SE)

(21) Appl. No.: 13/142,698

(22) PCT Filed: Jan. 2, 2009
(86) PCT No.: PCT/SE2009/050001

§ 371 Date: Jun. 29, 2011

(51) Int. Cl. H04W 28/02; H04L 12/56

(52) U.S. Cl. 370/230

(57) ABSTRACT

In one aspect, the invention provides an adaptive admission control method. In some embodiments, this method includes: (a) storing an admission control threshold value (ACTV) for a GBR capacity partition; (b) for at least a plurality of GBR bearers included in the GBR partition, determining a first performance value for the GBR bearer and determining whether the first performance value for the GBR bearer exceeds a first configured threshold; (c) determine a first percentage value identifying the percentage of GBR bearers included in the GBR capacity partition whose first performance value exceeds the first configured threshold; (d) comparing the first percentage value to a first performance threshold value; and (e) using the result of the comparison in determining whether the ACTV should be increased, decreased or remain the same.

### TECHNICAL FIELD

The present invention relates to admission control in a communication system.

### BACKGROUND

Mobile communications systems (e.g., communications systems based on standards like GSM, WCDMA and LTE) typically employ an admission control system to reserve certain resources for guaranteed bit rate (GBR) bearers, which most often carry real time services having high demands on latency and throughput. Services without any guaranteed performance are carried on non-GBR bearers, which typically are not governed by admission control (e.g., no set up requests are rejected).

The available resources of a system can be divided into partitions, and each partition may be associated with particular users or bearers. Some partitions may be associated with GBR bearers (these partitions are known as GBR partitions), while the remaining resources are associated with non-GBR services.

Partitioning the available resources into multiple GBR partitions allows reserving resources for certain GBR bearers or subscribers (e.g., premium subscribers). A drawback to this is that a particular GBR partition cannot be used by GBR services not assigned to the particular GBR partition, which may result in GBR bearer requests being blocked even though GBR resources are available. The alternative is to share a common partition between all GBR bearers. However, in a congestion situation, this would require soft congestion actions to admit a premium subscriber or bearer with high priority at the expense of a subscriber or bearer with a lower priority. Since a dropped call is perceived to be worse that having a call blocked at setup, deploying multiple partitions may be preferred.

Typically, each GBR partition has an associated threshold defining the amount of capacity assigned to the partition. The capacity can be expressed in terms of for example, number of consumers, bit rate, power, or other physical measure. There may also be a limit to the amount of resources available for all GBR partitions defined.

In a packet oriented radio access network (RAN), downlink and uplink traffic is scheduled by the base station. A congestion situation arises when the amount of traffic exceeds an available capacity. This causes packets to be stalled and buffered in the base station and/or in the mobile terminal (a.k.a., user equipment (UE)). If packets are delayed sufficiently long they may eventually be discarded.

What is desired are admission control systems and methods that make more efficient use of available capacity, governing the quality of service experienced.

### SUMMARY

In one aspect, the invention provides an adaptive admission control method. In some embodiments, this method, which may be performed by a base station, includes the following steps: storing an admission control threshold value for a guaranteed bit rate capacity partition, wherein the admission control threshold value defines the amount of capacity assigned to the guaranteed bit rate capacity partition; determining a value (% GBRBs1) representing the percentage of guaranteed bit rate bearers in the guaranteed bit rate capacity partition that do not meet a performance criteria or determining a value (% GBRBs2) representing the percentage of guaranteed bit rate bearers in the guaranteed bit rate capacity partition that meet a performance criteria; and using % GBRBs1 and/or % GBRBs2 in a process for modifying the admission control threshold value.

In some embodiments, the process for modifying the admission control threshold value includes the following steps: determining whether % GBRBs1 is greater than a threshold (R1); determining whether the admission control threshold value (ACTV) can be decreased; and decreasing the ACTV if (a) the ACTV can be decreased and (b) % GBRBs1>R1. The step of determining whether the ACTV can be decreased may include determining whether the ACTV is greater than (i) a minimum admission control threshold value plus (ii) a decrement value.

In some embodiments, the process for modifying the admission control threshold value includes the following steps: determining whether % GBRBs2 is greater than a threshold (R2); determining whether ACTV can be increased; determining, for the guaranteed bit rate capacity partition, the number of admission requests received in a window of time, the number of admission rejections in the window of time, and the number of soft congestions actions that were taken in the window of time; determining a ratio value identifying the ratio of admission rejections and soft congestions actions relative to the number of admission requests; comparing the ratio value to a performance criteria value; and increasing ACTV if (a) ACTV can be increased and (b) % GBRBs2>R2 and (c) the ratio value is greater than the performance criteria value. The step of determining whether the ACTV can be increased may include determining whether increasing the ACTV would cause the total amount of guaranteed bit rate capacity to exceed a predetermined total capacity.

In some embodiments, the step of determining % GBRBs1 includes: determining, for each of a plurality of guaranteed bit rate bearers included in the guaranteed bit rate capacity partition, a performance value (e.g., a computed average value) for the guaranteed bit rate bearer; and determining whether the performance value for the guaranteed bit rate bearer exceeds a performance threshold. In some embodiments, the step of determining % GBRBs2 includes: determining, for each of a plurality of guaranteed bit rate bearers included in the guaranteed bit rate capacity partition, the performance value for the guaranteed bit rate bearer; and determining whether the performance value for the guaranteed bit rate bearer is less than the performance threshold. The performance value for each guaranteed bit rate bearer may be one of: (a) an average downlink buffer size, (b) an average uplink buffer size, and (c) an average packet discard rate.

The step of determining % GBRBs1 may further include: determining, for each of a plurality of guaranteed bit rate bearers included in the guaranteed bit rate capacity partition, a second performance value and a third performance value for the guaranteed bit rate bearer; determining whether the second performance value for the guaranteed bit rate bearer exceeds a second performance threshold; determining whether the third performance value for the guaranteed bit rate bearer exceeds a third performance threshold; and determining the number of guaranteed bit rate bearers in the guaranteed bit rate capacity partition that do not meet the performance criteria, wherein a guaranteed bit rate bearer in the guaranteed bit rate capacity partition does not meet the performance criteria if: the first performance value for the guaranteed bit rate bearer exceeds the first performance threshold, the second performance value for the guaranteed bit rate bearer exceeds the second performance threshold, and the third performance value for the guaranteed bit rate bearer exceeds the third performance threshold. In some embodiments, the first performance value is an average downlink buffer size, the second performance value is an average uplink buffer size, and the third performance value is an average packet discard rate.

The step of determining % GBRBs2 may further include: determining, for each of a plurality of guaranteed bit rate bearers included in the guaranteed bit rate capacity partition, the second performance value and the third performance value for the guaranteed bit rate bearer; determining whether the second performance value for the guaranteed bit rate bearer is less than the second performance threshold; determining whether the third performance value for the guaranteed bit rate bearer is less than the third performance threshold; and determining the number of guaranteed bit rate bearers in the guaranteed bit rate capacity partition that meet the performance criteria, wherein a guaranteed bit rate bearer in the guaranteed bit rate capacity partition meets the performance criteria if: the first performance value for the guaranteed bit rate bearer is less than the first performance threshold, the second performance value for the guaranteed bit rate bearer is less than the second performance threshold, and the third performance value for the guaranteed bit rate bearer is less than the third performance threshold.

In another aspect, the present invention provides an apparatus (e.g., a base station) for performing an adaptive admission control method. In some embodiments, the apparatus includes: a data storage system that stores an admission control threshold value for a guaranteed bit rate capacity partition, wherein the admission control threshold value defines the amount of capacity assigned to the guaranteed bit rate capacity partition; a data processor coupled to the data storage system; and computer instructions stored in the data storage system, the computer instructions comprising: computer instructions configured to determine a value (% GBRBs1) representing the percentage of guaranteed bit rate bearers in the guaranteed bit rate capacity partition that do not meet a performance criteria and/or computer instructions configured to determine a value (% GBRBs2) representing the percentage of guaranteed bit rate bearers in the guaranteed bit rate capacity partition that meet a performance criteria; and computer instructions configured to use % GBRBs1 and/or % GBRBs2 to determine whether the admission control threshold value should be modified.

The above and other aspects and embodiments are described below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements.

FIG. 1 illustrates a portion of a mobile communications system according to some embodiments.

FIG. 2 is a diagram illustrating the partitioning of available capacity into a GBR partition and a Non-GBR partition.

FIG. 3 is a diagram illustrating that the GBR partition may be partitioned.

FIG. 4 is a diagram illustrating that the size of the GBR partitions may be adapted.

FIG. 5 is a flow chart illustrating a process according to some embodiments of the invention.

FIG. 6 is a flow chart illustrating a process according to some embodiments of the invention.

FIG. 7 is functional block diagram of a base station according to some embodiments of the invention.

### DETAILED DESCRIPTION

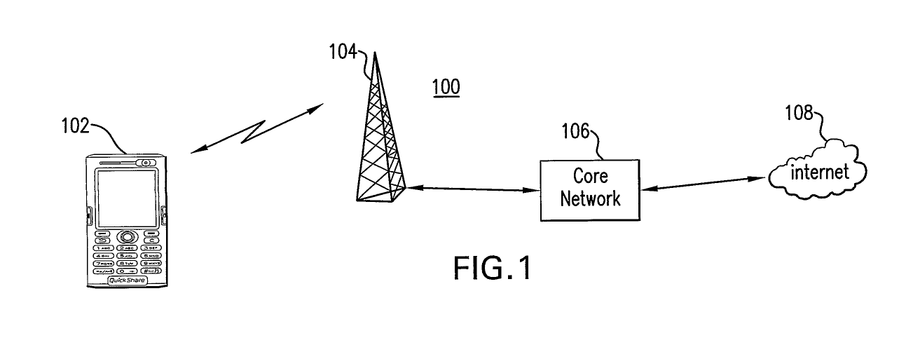

Referring now to FIG. 1, FIG. 1 illustrates a portion of a communications system 100, according to some embodiments. FIG. 1 shows a UE 102 in communication with a base station 104, which is in communication with a core network (CN) 106 (e.g., if base station 104 if part of, for example, an LTE network, base station 104 communicates with a core network node such as an mobility management entity (MME)—it is noted that the invention is also applicable to other networks, such as radio access networks where the base station connects to the CN via a radio network controller (RNC), additionally the CN node may be, for example, a mobile switching center (MSC) or media gateway (MGW)). Core network 106 may provide access to a network 108 (e.g., the Internet). In some embodiments, when a user of UE 102 desires to use a service (e.g., make a voice call or download a video), UE 102 establishes a signaling connection with a base station (e.g., base station 104), if such a connection is not already established. Once the connection with the base station is established, UE 102 transmits a service request to CN 106. CN 106 may then select a bearer and transmit to base station 104 a request message which includes a request for resources for the selected bearer and quality of service (QoS) parameters associated with the selected bearer. Base station 104 may use the QoS parameters to assign the selected bearer to a partition.

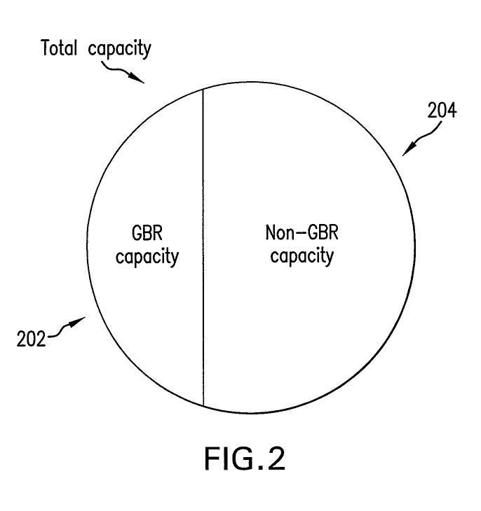

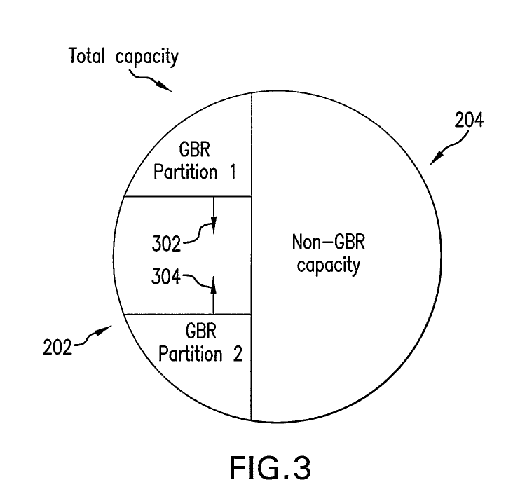

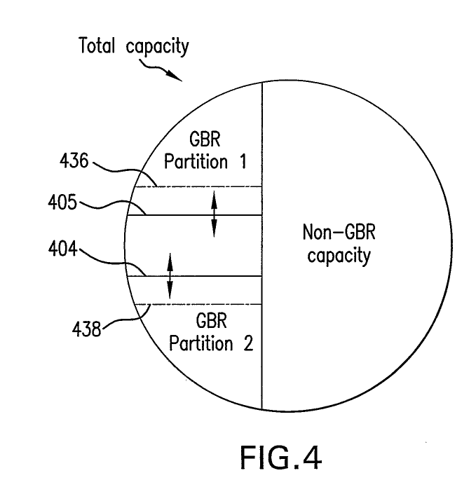

Referring now to FIG. 2, FIG. 2 illustrates the capacity of base station 104 and illustrates how this available capacity may be partitioned into a GBR partition 202 (e.g., capacity that may be used by both GBR bearers and non-GBR bearers, but the GBR bearers have priority over the non-GBR bearers) and a non-GBR partition 204 (e.g., capacity that may be used by non-GBR bearers but not GBR bearers). FIG. 3 illustrates that the GBR partition 202 itself may be divided into two or more GBR partitions. In the example shown, GBR partition 202 is subdivided into GBR partition 1 and GBR partition 2. Arrowed lines 302 and 304 represent that GBR partition 1 and GBR partition 2 may expand in size. For example, as shown in FIG. 4, if we assume GBR partition 202 is sub-divided into two partitions (GBR partition 1 and GBR partition 2), then solid line 405 represents the admission threshold for GBR partition 1 and solid line 404 represents the admission threshold for GBR partition 2. That is, the capacity above line 405 is allocated to GBR partition 1, while the capacity below line 404 is allocated to GBR partition 2. As further illustrated in FIG. 4, line 404 can move anywhere between dashed line 438 and solid line 405, but can not cross those lines. Similarly, solid line 405 can move anywhere between dashed line 436 and solid line 404, but can not cross those lines. Thus, in some embodiments, the capacity allocated to GBR partition 1 will not fall below a certain minimum threshold as represented by line 436, the capacity allocated to GBR partition 2 will not fall below a certain minimum threshold as represented by line 438, and the total amount of available GBR capacity is fixed.

Embodiments of the present invention are concerned with determining whether to automatically adapt an admission threshold for a GBR partition in order to resolve a congestion situation experienced by GBR bearers in a certain GBR partition. For example, in terms of the diagram shown in FIG. 4, embodiments of the invention are concerned with determining whether to move lines 404,405 up or down.

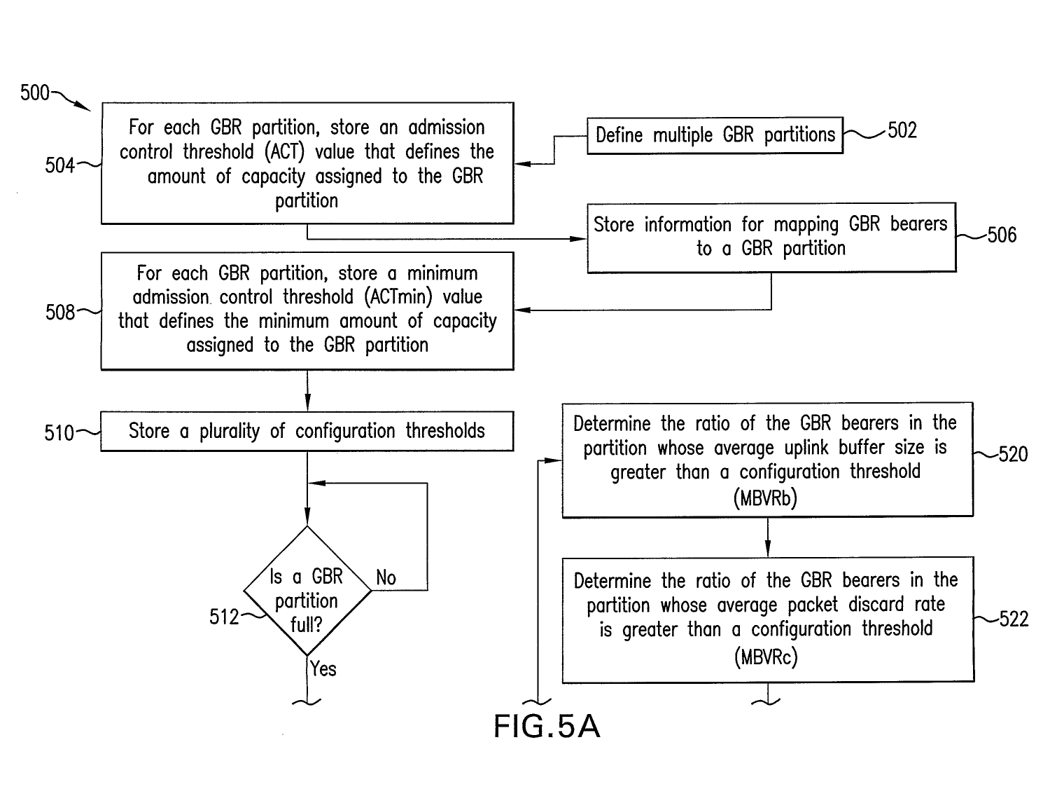

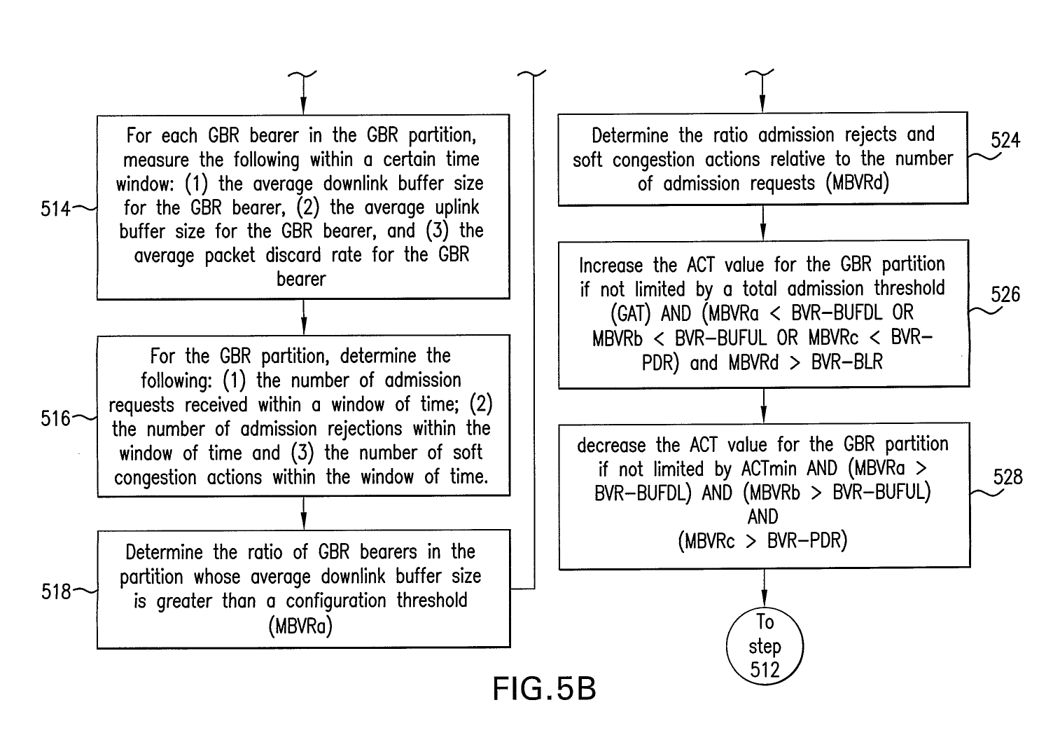

Referring now to FIG. 5, FIG. 5 is a flow chart illustrating a process 500 according to embodiments of the invention. Process 500 may begin in step 502, where multiple (i.e., two or more) GBR partitions are defined. In step 504, for each GBR partition, base station 104 stores an admission control threshold value (ACTV). This value represents the amount of capacity assigned to the GBR partition. In step 506, base station 104 stores information that is used to assign a GBR bearer to a GBR partition. In some embodiments, a GBR bearer is mapped to a GBR partition based on the QoS profile of the GBR bearer. For example, in some embodiments, base station 104 assigns a GBR bearer to a GBR partition based on a quality class indicator (QCI) and an allocation retention priority (APR) associated with the GBR bearer. Thus, in some embodiments, the information stored in step 506 specifies that any GBR bearer having a certain QoS profile should be assigned to a particular GBR partition.

In step 508, base station 104 stores, for each defined GBR partition, a minimum admission control threshold (ACTmin) value. Base station may also store threshold values R1 and R2. In step 508, base station 104 may also store an increment (ICR) value that is used when increasing or decreasing a GBR partition's ACT value.

In step 510, base station 104 stores a number of performance criteria values and other configuration values. For example, in step 510, base station 104 may store: (1) a packet discard rate (PDR) defining an upper bound for an acceptable downlink PDR; (2) one or more blocking rates (BLRs) defining an upper bound for an acceptable rate of admission rejects and/or soft congestion actions (in some embodiments there is a BLR for admission rejects and a BLR for soft congestion actions); (3) a downlink buffer size (BUFDL) defining an upper bound of an acceptable buffer size per bearer in downlink; (4) an uplink buffer size (BUFUL) defining an upper bound of an acceptable buffer size per bearer in uplink; (5) a GBR admission threshold (GAT), defining the upper bound of the capacity assigned to all GBR bearers; and (6) thresholds defining upper bounds for the acceptable the rate of bearers per partition violating each partition performance criteria (BVR-X) where X={PDR, BLR, BUFDL, BUFUL}. Performance criteria values (1), (3) and (4) may be defined on a per bearer or quality of service (QoS) class basis or partition bases, and performance criteria value (2) is defined on a per partition basis.

In step 512, base station 104 determines whether a GBR partition is full. In some embodiments, a GBR partition is considered to be full if it cannot admit another GBR bearer. If no GBR partition is full, step 512 may be repeated at another time, otherwise, process 500 proceeds to step 514.

In step 514, for each GBR bearer in the GBR partition, base station 104 measures the following performance values for a certain window of time: (1) the average downlink buffer size for the GBR bearer, (2) the average uplink buffer size for the GBR bearer, and (3) the average packet discard rate for the GBR bearer.

In step 516, for the GBR partition, base station 104 determines: (1) the number of admission requests received within a window of time; (2) the number of admission rejections within the window of time and (3) the number of soft congestion actions within the window of time.

In step 518, base station 104 determines the ratio of GBR bearers in the partition whose average downlink buffer size is greater than BUFDL (MBVRa). In step 520, base station 104 determines the ratio of GBR bearers in the partition whose average uplink buffer size is greater than BUFUL (MBVRb). In step 522, base station 104 determines the ratio of GBR bearers in the partition whose average packet discard rate is greater than PDR (MBVRc). In step 524, base station 104 determines the ratio of admission rejects and soft congestion actions relative to the number of admission requests (MBVRd).

In step 526, base station 104 increases the ACT value for the GBR partition if (a) doing so would not cause the amount of GBR capacity to exceed GAT AND (b) (MBVRa<BVR−BUFDL AND/OR MBVRb<BVR−BUFUL AND/OR MBVRc<BVR−PDR) AND (c) (MBVRd>BVR−BLR).

In step 528, base station 104 decreases the ACT value for the GBR partition if (a) not limited by the minimum admission control threshold (i.e., if (ACTV−INC)>ACTmin) AND (b) (MBVRa>BVR−BUFDL) AND/OR (MBVRb>BVR−BUFUL) AND/OR (MBVRc>BVR−PDR).

After step 528, process 500 may return to step 512. Some of the above steps of process 500 may be optional. For example, in some embodiments, step 512 is optional.

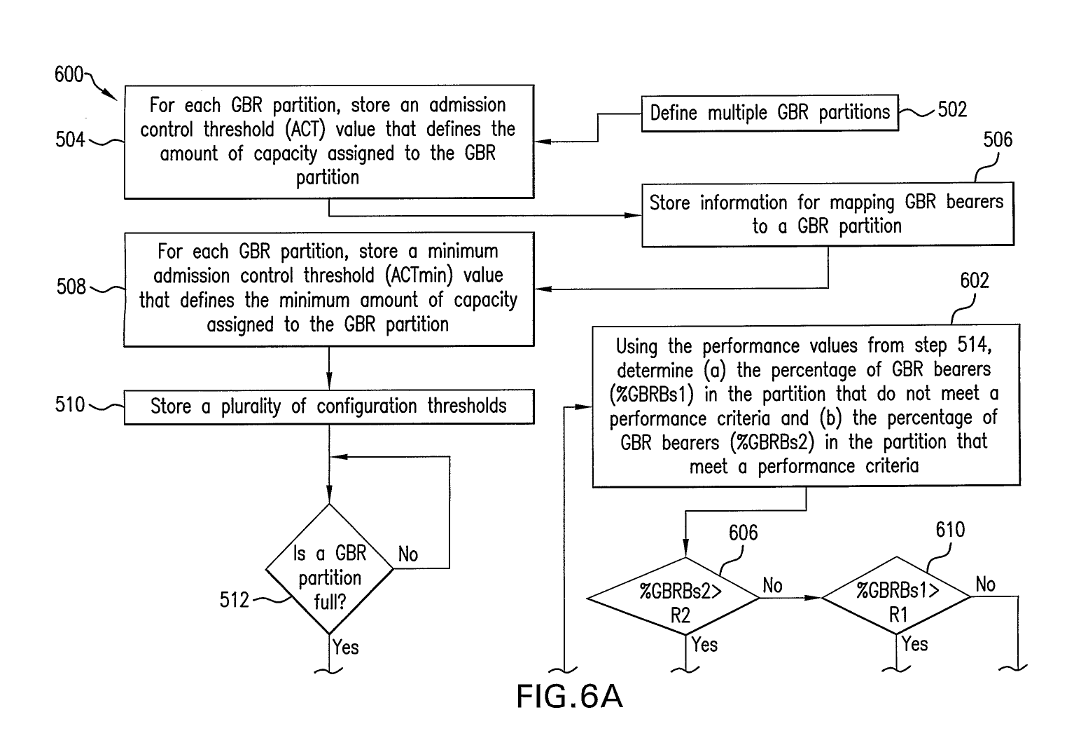

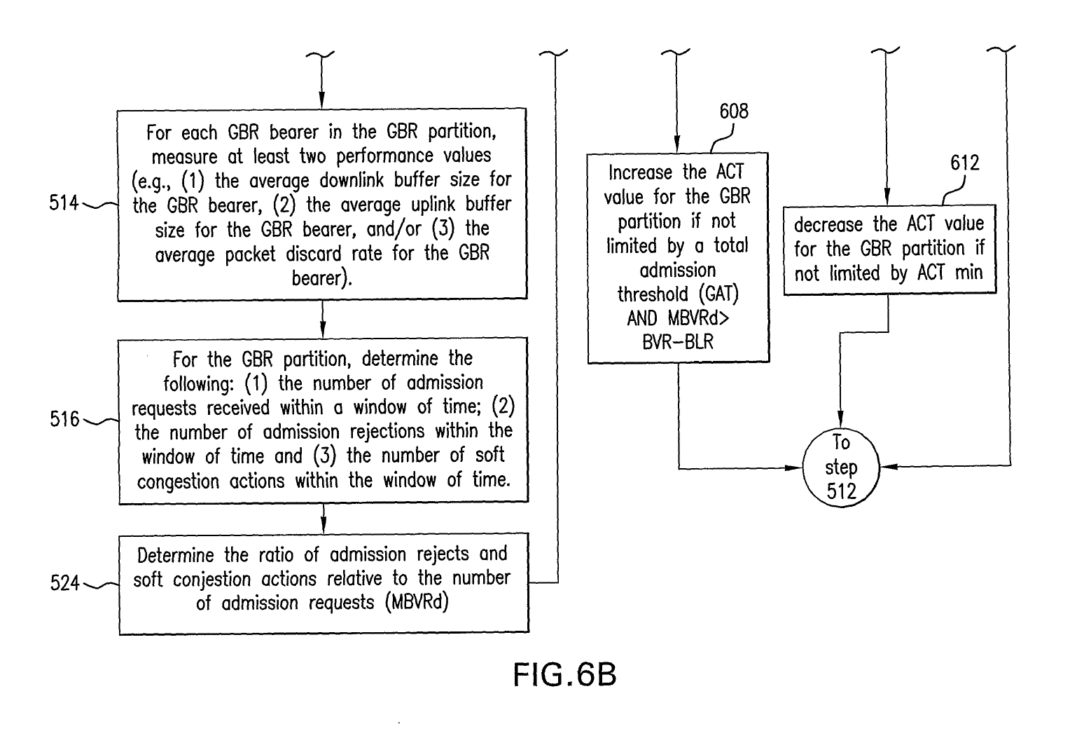

Referring now to FIG. 6, FIG. 6 is a flow chart illustrating a process 600 according to some embodiments of the invention. As illustrated, many of the steps of process 600 are the same as steps from process 500. The description if these steps will not be repeated.

In step 602, the percentage of GBR bearers (% GBRBs1) in the full partition that do not meet a performance criteria is determined and the percentage of GBR bearers (% GBRBs2) in the full partition that meet a performance criteria is determined.

In some embodiments, a GBR bearer does not meet the performance criteria if: (1) the average downlink buffer size for the GBR bearer is greater than BUFDL, (2) the average uplink buffer size for the GBR bearer is greater than BUFUL, and (3) the average packet discard rate for the GBR bearer is greater than PDR. In another embodiment, a GBR bearer does not meet the performance criteria if: (1) the average downlink buffer size for the GBR bearer is greater than BUFDL, (2) the average uplink buffer size for the GBR bearer is greater than BUFUL, or (3) the average packet discard rate for the GBR bearer is greater than PDR. In yet another embodiment, a GBR bearer does not meet the performance criteria if: (1) (a) the average downlink buffer size for the GBR bearer is greater than BUFDL and (b) the average uplink buffer size for the GBR bearer is greater than BUFUL, (2) (a) the average downlink buffer size for the GBR bearer is greater than BUFDL and (b) the average packet discard rate for the GBR bearer is greater than PDR, or (3)(a) the average uplink buffer size for the GBR bearer is greater than BUFUL and (b) the average packet discard rate for the GBR bearer is greater than PDR.

In some embodiments, a GBR bearer meets the performance criteria if: (1) the average downlink buffer size for the GBR bearer is less than BUFDL, (2) the average uplink buffer size for the GBR bearer is less than BUFUL, and (3) the average packet discard rate for the GBR bearer is less than PDR. In another embodiment, a GBR bearer meets the performance criteria if: (1) the average downlink buffer size for the GBR bearer is less than BUFDL, (2) the average uplink buffer size for the GBR bearer is less than BUFUL, or (3) the average packet discard rate for the GBR bearer is less than PDR. In yet another embodiment, a GBR bearer meets the performance criteria if: (1) (a) the average downlink buffer size for the GBR bearer is less than BUFDL and (b) the average uplink buffer size for the GBR bearer is less than BUFUL, (2) (a) the average downlink buffer size for the GBR bearer is less than BUFDL and (b) the average packet discard rate for the GBR bearer is less than PDR, or (3)(a) the average uplink buffer size for the GBR bearer is less than BUFUL and (b) the average packet discard rate for the GBR bearer is less than PDR.

In step 606, a determination is made as to whether % GBRBs2 is greater than R2. If it is, then process 600 proceeds to step 608, otherwise it proceeds to step 610. In step 608, base station 104 increases the ACT value for the GBR partition if (a) doing so would not cause the amount of GBR capacity to exceed GAT AND (b) (MBVRd>BVR−BLR).

In step 610, a determination is made as to whether % GBRBs1 is greater than R1. If it is, then process 600 proceeds to step 612, otherwise it proceeds back to step 626. In step 612, base station 104 decreases the ACT value for the GBR partition if not limited by the minimum admission control threshold (i.e., if (ACTV−INC)>ACTmin).

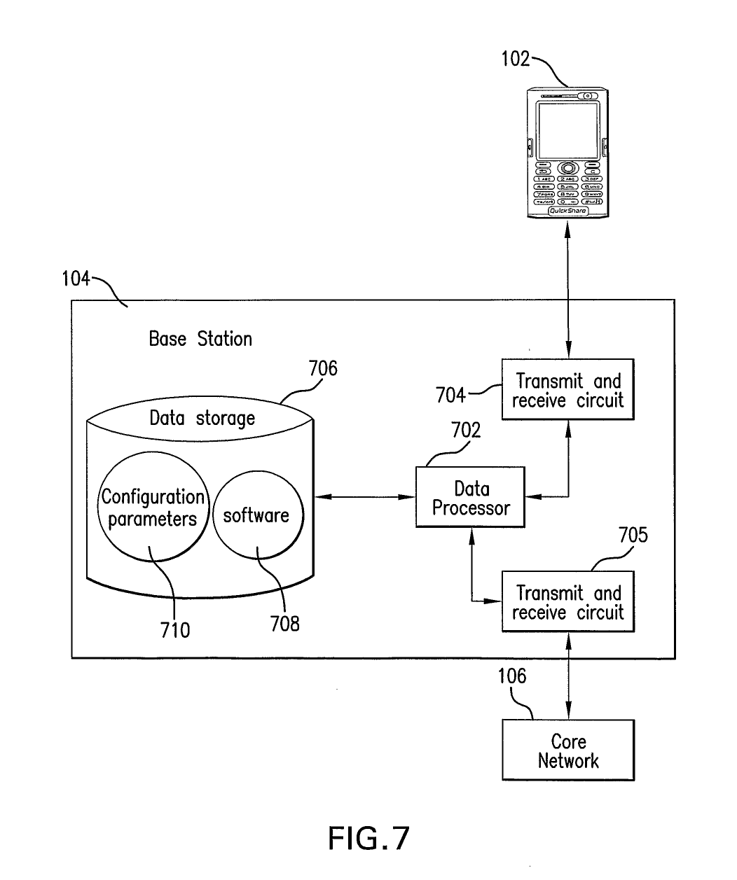

Referring now to FIG. 7, FIG. 7 is a functional block diagram of base station 104 according to some embodiments of the invention. As shown, base station 104 may comprise a data processing system 702 (e.g., one or more microprocessors), a data storage system 706 (e.g., one or more non-volatile storage devices) and computer software 708 stored on the storage system 706. Configuration parameters 710 (e.g., the above mentioned performance criteria values and other configuration values) may also be stored in storage system 706. Base station 104 also may comprise transmit/receive (Tx/Rx) circuitry 704 for transmitting data to and receiving data from UE 102 and transmit/receive (Tx/Rx) circuitry 705 for transmitting data to and receiving data from CN 106. Software 708 is configured such that when processor 702 executes software 708, base station 104 performs steps described above with reference process 500 and/or 600.

While various embodiments of the present invention have been described above, it should be understood that they have been presented by way of example only, and not limitation. Thus, the breadth and scope of the present invention should not be limited by any of the above-described exemplary embodiments.

Additionally, while the process described above and illustrated in FIGS. 5 and 6 are shown as a sequence of steps, this was done solely for the sake of illustration. Accordingly, it is contemplated that some steps may be added, some steps may be omitted, the order of the steps may be re-arranged, and some steps may be performed in parallel.

1-25. (canceled)

26. An adaptive admission control method, comprising:
storing an admission control threshold value for a guaranteed bit rate capacity partition, wherein the admission control threshold value defines the amount of capacity assigned to the guaranteed bit rate capacity partition;
determining at least one of a first value representing the percentage of guaranteed bit rate bearers in the guaranteed bit rate capacity partition that do not meet a performance criteria and a second value representing the percentage of guaranteed bit rate bearers in the guaranteed bit rate capacity partition that meet the performance criteria; and
using at least one of the first value and the second value in a process for modifying the admission control threshold value.

27. The method of claim 26, wherein the process for modifying the admission control threshold value comprises:
determining whether the first value is greater than a first threshold;
determining whether the admission control threshold value can be decreased; and
decreasing the admission control threshold value if both the admission control threshold value can be decreased and the first value is greater than the first threshold.

28. The method of claim 27, wherein determining whether the admission control threshold value can be decreased comprises determining whether the admission control threshold value is greater than the addition of a minimum admission control threshold value and a decrement value.

29. The method of claim 26, wherein the process for modifying the admission control threshold value comprises:
determining whether the second value is greater than a second threshold
determining whether the admission control threshold value can be increased;
determining, for the guaranteed bit rate capacity partition, a number of admission requests received in a window of time, a number of admission rejections in the window of time, and a number of soft congestion actions that were taken in the window of time;
determining a ratio value identifying the ratio of admission rejections and soft congestions actions relative to the number of admission requests;
comparing the ratio value to a performance criteria value; and
increasing the admission control threshold value if the admission control threshold value can be increased, the second value is greater than the second threshold, and the ratio value is greater than the performance criteria value.

30. The method of claim 29, wherein determining whether the admission control threshold value can be increased comprises determining whether increasing the admission control threshold value would cause a total amount of guaranteed bit rate capacity to exceed a predetermined total capacity.

31. The method of claim 26, further comprising determining a first performance value for each of a plurality of guaranteed bit rate bearers included in the guaranteed bit rate capacity partition, wherein determining the first value comprises determining whether the first performance value determined for each guaranteed bit rate bearer exceeds a first performance threshold, and wherein determining the second value comprises determining whether the first performance value determined for each guaranteed bit rate bearer is less than the first performance threshold.

32. The method of claim 31, wherein the first performance value determined for each guaranteed bit rate bearer is a computed average value.

33. The method of claim 32, wherein the first performance value determined for each guaranteed bit rate bearer is one of:
an average downlink buffer size,
an average uplink buffer size, and
an average packet discard rate.

34. The method of claim 31, further comprising determining a second performance value for each guaranteed bit rate bearer, wherein determining the first value further comprises determining whether the second performance value determined for each guaranteed bit rate bearer exceeds a second performance threshold, and wherein determining the second value further comprises determining whether the second performance value determined for each guaranteed bit rate bearer is less than the second performance threshold.

35. The method of claim 34, further comprising determining a third performance value for each guaranteed bit rate bearer, wherein determining the first value further comprises determining whether the third performance value determined for each guaranteed bit rate bearer exceeds a third performance threshold, and wherein determining the second value further comprises determining whether the third performance value determined for each guaranteed bit rate bearer is less than the third performance threshold.

36. The method of claim 35, wherein
determining the first value further comprises determining the number of guaranteed bit rate bearers in the guaranteed bit rate capacity partition that do not meet the performance criteria, wherein a guaranteed bit rate bearer in the guaranteed bit rate capacity partition does not meet the performance criteria if the first performance value for the guaranteed bit rate bearer exceeds the first performance threshold, the second performance value for the guaranteed bit rate bearer exceeds the second performance threshold, and the third performance value for the guaranteed bit rate bearer exceeds the third performance threshold, and
determining the second value further comprises determining the number of guaranteed bit rate bearers in the guaranteed bit rate capacity partition that meet the performance criteria, wherein a guaranteed bit rate bearer in the guaranteed bit rate capacity partition meets the performance criteria if the first performance value for the guaranteed bit rate bearer is less than the first performance threshold, the second performance value for the guaranteed bit rate bearer is less than the second performance threshold, and the third performance value for the guaranteed bit rate bearer is less than the third performance threshold.

37. The method of claim 35, wherein:
the first performance value is an average downlink buffer size,
the second performance value is an average uplink buffer size, and
the third performance value is an average packet discard rate.

38. The method of claim 26, wherein the method is performed by a base station.

39. An apparatus for adaptive admission control, the apparatus comprising:
a data storage system that stores an admission control threshold value for a guaranteed bit rate capacity partition, wherein the admission control threshold value defines the amount of capacity assigned to the guaranteed bit rate capacity partition;
a data processor configured to:
determine at least one of a first value representing the percentage of guaranteed bit rate bearers in the guaranteed bit rate capacity partition that do not meet a performance criteria and a second value representing the percentage of guaranteed bit rate bearers in the guaranteed bit rate capacity partition that meet the performance criteria; and
use at least one of the first value and the second value in a process for modifying the admission control threshold value.

40. The apparatus of claim 39, wherein the data processor is configured to modify the admission control threshold value by:
comparing the first value to a first threshold,
determining whether the admission control threshold can be decreased; and
decreasing the admission control threshold value if both the admission control threshold value can be decreased and the first value is greater than the first threshold.

41. The apparatus of claim 40, wherein the data processor is configured to determine whether the admission control threshold can be decreased by determining whether the admission control threshold value is greater than the addition of a minimum admission control threshold value and a decrement value.

42. The apparatus of claim 39, wherein the data processor is configured to modify the admission control threshold value by:
comparing the second value to a second threshold,
determining whether the admission control threshold value can be increased;
determining, for the guaranteed bit rate capacity partition, a number of admission requests received in a window of time, a number of admission rejections in the window of time, and a number of soft congestion actions that were taken in the window of time;
determining a ratio value identifying the ratio of admission rejections and soft congestions actions relative to the number of admission requests;
comparing the ratio value to a performance criteria value; and
increasing the admission control threshold value if the admission control threshold value can be increased, the second value is greater than the second threshold, and the ratio value is greater than the performance criteria value.

43. The apparatus of claim 42, wherein the data processor is configured to determine whether the admission control threshold value can be increased by determining whether increasing the admission control threshold value would cause a total amount of guaranteed bit rate capacity to exceed a predetermined total capacity.

44. The apparatus of claim 39, wherein the data processor is further configured to determine a first performance value for each of a plurality of guaranteed bit rate bearers included in the guaranteed bit rate capacity partition, wherein the data processor is configured to determine the first value by determining whether the first performance value determined for each guaranteed bit rate bearer exceeds a first performance threshold, and wherein the data processor is configured to determine the second value by determining whether the first performance value determined for each guaranteed bit rate bearer is less than the first performance threshold.

45. The apparatus of claim 44, wherein the first performance value determined for each guaranteed bit rate bearer is a computed average value.

46. The apparatus of claim 45, wherein the first performance value determined for each guaranteed bit rate bearer is one of:
an average downlink buffer size,
an average uplink buffer size, and
an average packet discard rate.

47. The apparatus of claim 44, wherein the data processor is further configured to determine a second performance value for each guaranteed bit rate bearer, wherein the data processor is configured to determine the first value by determining whether the second performance value determined for each guaranteed bit rate bearer exceeds a second performance threshold, and wherein the data processor is configured to determine the second value by determining whether the second performance value determined for each guaranteed bit rate bearer is less than the second performance threshold.

48. The apparatus of claim 47, wherein the data processor is further configured to determine a third performance value for each guaranteed bit rate bearer, wherein the data processor is configured to determine the first value by determining whether the third performance value determined for each guaranteed bit rate bearer exceeds a third performance threshold, and wherein the data processor is configured to determine the second value by determining whether the third performance value determined for each guaranteed bit rate bearer is less than the third performance threshold.

49. The apparatus of claim 48, wherein:
the data processor is configured to determine the first value by determining the number of guaranteed bit rate bearers in the guaranteed bit rate capacity partition that do not meet the performance criteria, wherein a guaranteed bit rate bearer in the guaranteed bit rate capacity partition does not meet the performance criteria if the first performance value for the guaranteed bit rate bearer exceeds the first performance threshold, the second performance value for the guaranteed bit rate bearer exceeds the second performance threshold, and the third performance value for the guaranteed bit rate bearer exceeds the third performance threshold, and
the data processor is configured to determine the second value by determining the number of guaranteed bit rate bearers in the guaranteed bit rate capacity partition that meet the performance criteria, wherein a guaranteed bit rate bearer in the guaranteed bit rate capacity partition meets the performance criteria if the first performance value for the guaranteed bit rate bearer is less than the first performance threshold, the second performance value for the guaranteed bit rate bearer is less than the second performance threshold, and the third performance value for the guaranteed bit rate bearer is less than the third performance threshold.

50. The apparatus of claim 48, wherein:
the first performance value is an average downlink buffer size,
the second performance value is an average uplink buffer size, and
the third performance value is an average packet discard rate.
